(19) United States
(12) Patent Application Publication
(10) Pub. No.: US 2026/0287385 A1
(43) Pub. Date: Sep. 24, 2026

(54) INFORMATION OUTPUT DEVICE, INFORMATION OUTPUT METHOD, AND STORAGE MEDIUM

(71) Applicant: HONDA MOTOR CO., LTD., Tokyo (JP)

(72) Inventors: Yugo Kajiwara, Tokyo (JP); Satoshi Sadamura, Tokyo (JP); Kazuki Kamata, Tokyo (JP)

(21) Appl. No.: 19/544,064

(22) Filed: Feb. 19, 2026

(30) Foreign Application Priority Data
Mar. 19, 2025 (JP) 2025-045390

(51) Int. Cl. G01C 21/36; B60Q 9/00

(52) U.S. Cl. CPC G01C 21/3658; B60Q 9/00

(57) ABSTRACT

An information output device includes an output interface provided in a cabin of a vehicle and an output controller configured to use the output interface to output guidance information that is information for guiding an occupant so that a vehicle moves outside a host lane that is a lane in which the vehicle is traveling among one or more lanes formed on a road where the vehicle is located. The output controller differentiates an output position of the guidance information in accordance with a type of movement.

### CROSS-REFERENCE TO RELATED APPLICATION

This application is based upon and claims the benefit of priority from Japanese Patent Application No. 2025-045390, filed Mar. 19, 2025, the entire content of which is incorporated herein by reference.

### BACKGROUND

### Field of the Invention

The present invention relates to an information output device, an information output method, and a storage medium.

### Description of Related Art

Recently, efforts to provide access to sustainable transportation systems have been increasingly active in consideration of vulnerable individuals among participants in transportation. For this realization, research and development efforts are focused on further improving the safety and convenience of transportation through research and development related to autonomous driving techniques. Meanwhile, driving assistance techniques include a known technique in which, when a vehicle changes lanes, among a plurality of illuminations provided on the vehicle’s instrument panel (also referred to as a dashboard or front garnish), door trims, and the like, the illumination in a direction in which the vehicle moves due to the lane change (e.g., the illumination on the right side of the vehicle interior in the case of a lane change to a right lane) is turned on (see, for example, PCT International Publication No. WO/2021/131789 and Japanese Unexamined Patent Application, First Publication No. 2010-264952).

### SUMMARY

Out-of-lane movement such as a lane change include several types of movements. For example, they include movements for changing a travel route from one road to another, such as right turns or left turns, movements for simply changing lanes within the same road without changing the travel route, and the like. In conventional techniques, illumination is uniformly turned on regardless of the type of vehicle movement. Thus, when the vehicle moves, a sense of anxiety may be given to an occupant.

In order to solve the above problem, an objective of the present invention is to provide an information output device, an information output method, and a storage medium for reducing a sense of anxiety experienced by occupants when a vehicle is in motion. The present invention contributes to the development of sustainable transportation systems.

An information output device, an information output method, and a storage medium according to the present invention adopt the following configurations.
(1) According to a first aspect of the present invention, there is provided an information output device including: an output interface provided in a cabin of a vehicle; and an output controller configured to use the output interface to output guidance information that is information for guiding an occupant so that a vehicle moves outside a host lane that is a lane in which the vehicle is traveling among one or more lanes formed on a road where the vehicle is located, wherein the output controller differentiates an output position of the guidance information in accordance with a type of movement.
(2) According to a second aspect of the present invention, in the first aspect, the output interface includes a first optical notifier and a second optical notifier installed at a position different from that of the first optical notifier, and the output controller outputs the guidance information using the first optical notifier when the movement is a lane change to an adjacent lane that is adjacent to the host lane; and outputs the guidance information using the second optical notifier when the movement is movement from the road to a branching road, when the movement is movement from a merging road that connects the road and another road to the other road, when the movement is a right turn, or when the movement is a left turn,
(3) According to a third aspect of the present invention, in the first aspect, the guidance information includes a proposal of the movement for the occupant.
(4) According to a fourth aspect of the present invention, in the third aspect, the information output device further includes an input interface operated by the occupant, wherein, when an approval operation, which is an operation by the occupant for approving the proposal, is input to the input interface, the output controller differentiates an aspect of the guidance information to be output using the output interface.
(5) According to a fifth aspect of the present invention, in the fourth aspect, the input interface includes a turn signal lever, and the approval operation is an operation in which the turn signal lever is operated to actuate, among a plurality of turn signals provided on left and right sides of the vehicle, a turn signal in a direction identical to a direction of the movement proposed for the occupant.
(6) According to a sixth aspect of the present invention, in the fourth aspect, the output interface includes a speaker, and the output controller: causes the guidance information to be output as a sound from the speaker; and differentiates an aspect of the sound output from the speaker when the approval operation is input to the input interface.
(7) According to a seventh aspect of the present invention, in the second aspect, the first optical notifier is provided on an inner side of a door of the vehicle, and the second optical notifier is provided on an instrument panel of the vehicle.
(8) According to an eighth aspect of the present invention, there is provided an information output method using a computer mounted on a vehicle where an output interface is provided in a cabin, the information output method including: using the output interface to output guidance information that is information for guiding an occupant so that a vehicle moves outside a host lane that is a lane in which the vehicle is traveling among one or more lanes formed on a road where the vehicle is located; and differentiating an output position of the guidance information in accordance with a type of movement.
(9) According to a ninth aspect of the present invention, there is provided a non-transitory storage medium storing a program for causing a computer, which is mounted on a vehicle where an output interface is provided in a cabin, to: use the output interface to output guidance information that is information for guiding an occupant so that a vehicle moves outside a host lane that is a lane in which the vehicle is traveling among one or more lanes formed on a road where the vehicle is located; and differentiate an output position of the guidance information in accordance with a type of movement.

According to the above-described aspect, it is possible to clearly notify an occupant of a type of out-of-lane movement by differentiating an output position of guidance information in accordance with a type of out-of-lane movement of the vehicle. As a result, it is possible to reduce a sense of anxiety experienced by the occupant when the vehicle moves.

### BRIEF DESCRIPTION OF THE DRAWINGS

FIG. 1 is a configuration diagram of a vehicle system using an information output device of a first embodiment.

FIG. 2 is a diagram schematically showing a state of the interior of a host vehicle.

FIG. 3 is a functional configuration diagram of a first controller, a second controller, and a third controller of the first embodiment.

FIG. 4 is a flowchart showing an example of a series of processing steps performed by an autonomous driving control device of the first embodiment.

FIG. 5 is a diagram showing an example of a situation in which movement of type (i) is executed.

FIG. 6 is a diagram schematically showing a state in which guidance information is output.

FIG. 7 is a diagram showing an example of a situation in which movement of any of types (ii) to (iv) is executed.

FIG. 8 is a diagram schematically showing a state in which guidance information is output.

FIG. 9 is a flowchart showing an example of a flow of a series of processing steps of an autonomous driving control device of a second embodiment.

### DESCRIPTION OF EMBODIMENTS

Hereinafter, embodiments of an information output device, an information output method, and a storage medium of the present invention will be described with reference to the drawings.

### First embodiment

An information output device of a first embodiment, for example, is mounted on an autonomous driving vehicle. For example, autonomous driving is a process for controlling the driving of a vehicle by controlling one or both of the vehicle’s speed and steering. For example, the above-described process for controlling the driving of the vehicle may include various types of driving control such as an adaptive cruise control system (ACC), a traffic jam pilot (TJP), an automated lane change (ALC), a collision mitigation brake system (CMBS), and a lane keeping assistance system (LKAS). Autonomous driving vehicles may be controlled by manual driving by an occupant (driver). Although a case where left-hand traffic regulations are applied will be described below, it is only necessary to reverse the left and right when right-hand traffic regulations are applied.

### Overall configuration

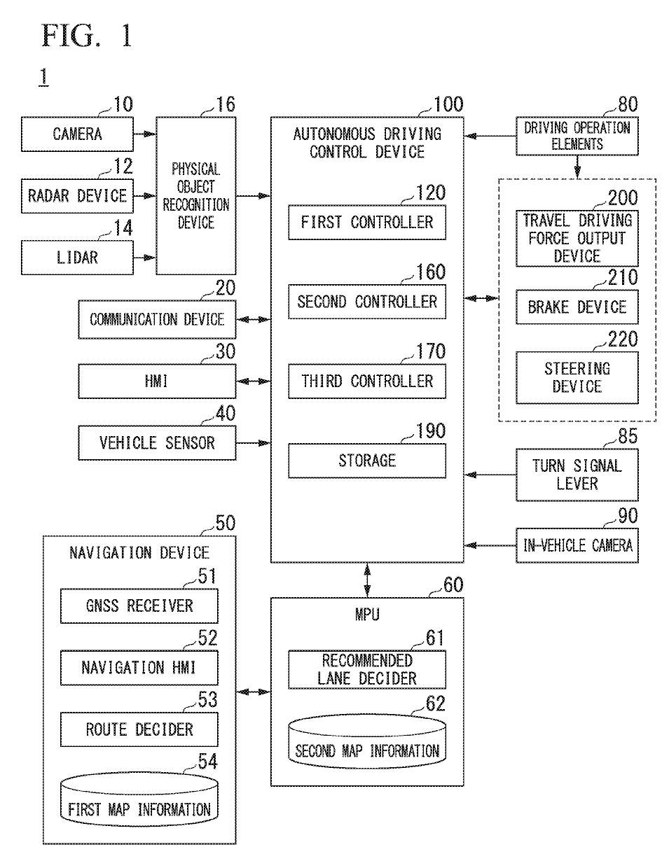

FIG. 1 is a configuration diagram of a vehicle system 1 using the information output device according to the present embodiment. A vehicle (hereinafter referred to as a host vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery or a fuel cell is discharged.

For example, the vehicle system 1 includes a camera 10, a radar device 12, a light detection and ranging (LIDAR) 14, a physical object recognition device 16, a communication device 20, a human machine interface (HMI) 30, a vehicle sensor 40, a navigation device 50, a map positioning unit (MPU) 60, driving operation elements 80, a turn signal lever 85, an in-vehicle camera 90, an autonomous driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. A combination of the HMI 30 and the autonomous driving control device 100 is an example of an “information output device.”

For example, the camera 10 is a digital camera using a solid-state imaging element such as a charge-coupled device (CCD) or a complementary metal oxide semiconductor (CMOS). The camera 10 is attached to any location on the host vehicle M. For example, when the view in front of the host vehicle M is imaged, the camera 10 is attached to an upper part of a front windshield, a rear surface of a rearview mirror, or the like. Moreover, when the view to the rear of the host vehicle M is imaged, the camera 10 may be attached to an upper part of a rear windshield, or the like. Moreover, when the view to the right or left side of the host vehicle M is imaged, the camera 10 may be attached to a right or left side surface of a vehicle body or a door mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position of a physical object (a distance from the physical object and a direction of the physical object) by detecting radio waves (reflected waves) reflected by the physical object near the host vehicle M. The radar device 12 is attached to any location on the host vehicle M. The radar device 12 may detect a position and a speed of the physical object in a frequency-modulated continuous wave (FM-CW) scheme.

The LIDAR 14 radiates light to the vicinity of the host vehicle M and measures scattered light from the radiated light. The LIDAR 14 detects a distance from an object on the basis of time from light emission to light reception. The radiated light is, for example, pulsed laser light. The LIDAR 14 is attached to any location on the host vehicle M.

The physical object recognition device 16 recognizes a position, type, and speed of the physical object and the like by performing a sensor fusion process on detection results from some or all of the camera 10, the radar device 12, and the LIDAR 14. The physical object recognition device 16 outputs a recognition result to the autonomous driving control device 100. The physical object recognition device 16 may output the detection results of the camera 10, the radar device 12, and the LIDAR 14 to the autonomous driving control device 100 as they are. The physical object recognition device 16 may be omitted from the vehicle system 1.

The communication device 20, for example, communicates with another vehicle located in the vicinity of the host vehicle M using, for example, a cellular network, a Wi-Fi network, Bluetooth (registered trademark), dedicated short-range communication (DSRC), or the like or communicates with various types of server devices via a radio base station.

The HMI 30 outputs various types of information to occupants of the host vehicle M and receives input operations from the occupants. For example, the HMI 30 includes an optical notifier 32 and a speaker 34. The HMI 30 is an example of an “output interface.”

The optical notifier 32 includes, for example, a first ambient light 32A, a second ambient light 32B, a third ambient light 32C, a first display 32D, and a second display 32E. The first ambient light 32A is an example of a “first optical notifier,” and the second ambient light 32B and the third ambient light 32C are examples of a “second optical notifier.”

The HMI 30 may further include a touch panel, a microphone, switches, buttons, and the like.

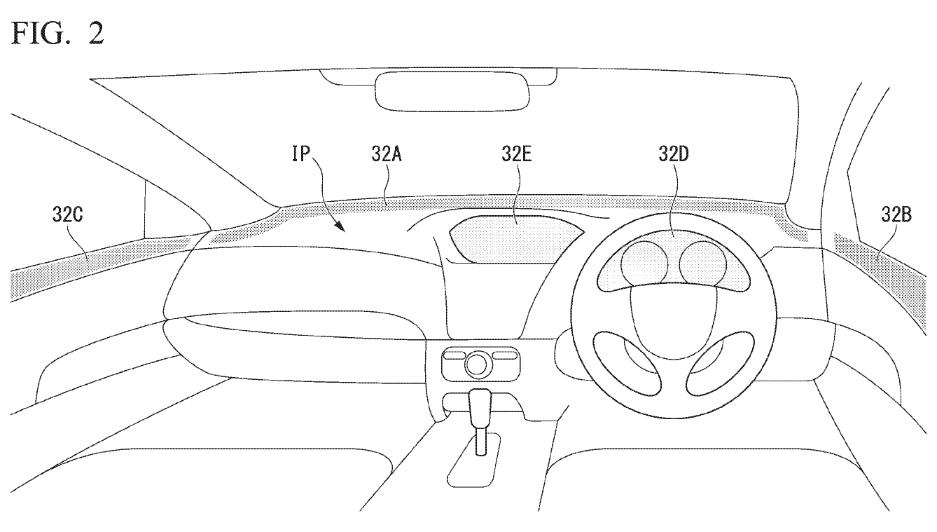

FIG. 2 is a view schematically showing a state of the interior of the host vehicle M. The first ambient light 32A may be provided, for example, on an instrument panel IP (also referred to as a dashboard or front garnish) to surround the driver’s seat (the seat closest to the steering wheel) and the passenger seat.

The second ambient light 32B may be provided, for example, on a door trim of the driver’s seat (the seat closest to the steering wheel). The third ambient light 32C may be provided, for example, on a door trim of the passenger seat.

The first ambient light 32A, the second ambient light 32B, and the third ambient light 32C are typically light emitting diode (LED) lamps or LED indicators, but are not limited thereto, and may be liquid crystal display (LCD) panels or organic electro luminescence (EL) displays. In other words, each of the first ambient light 32A, the second ambient light 32B, and the third ambient light 32C may be appropriately read as a display. In particular, a display used in place of the first ambient light 32A may be arranged above the first display 32D or the second display 32E on the instrument panel IP. Hereinafter, an example in which the first ambient light 32A, the second ambient light 32B, and the third ambient light 32C are LED lamps will be described.

The first ambient light 32A, the second ambient light 32B, and the third ambient light 32C are turned on or blink to notify occupants of guidance information.

The guidance information is information for guiding the occupant so that the host vehicle M moves outside a lane in which the host vehicle M is traveling, i.e., the host lane.

Movement outside the host lane includes, for example, (i) making the lane change from the host lane to an adjacent lane, (ii) moving to a branching road, (iii) moving from a merging road to a main road, (iv) making a right turn or a left turn, and the like.

The first display 32D is provided near the front of the driver’s seat on the instrument panel IP, and is installed at a position visible to an occupant through a gap in the steering wheel or over the steering wheel.

The second display 32E is installed, for example, near the center of the instrument panel IP.

The first display 32D and the second display 32E are typically LCDs or organic EL displays.

On the first display 32D, information necessary for traveling of the host vehicle M during manual driving or during driving assistance is displayed as images. The information necessary for traveling of the host vehicle M during manual driving includes, for example, a speed of the host vehicle M, an engine speed, the remaining fuel amount, a radiator water temperature, a travel distance, the remaining battery amount, and other information. The information necessary for traveling of the host vehicle M during driving assistance includes, for example, information about a future trajectory (a target trajectory to be described below) of the host vehicle M, the presence or absence of a lane change, a destination lane of the lane change, recognized lanes (markings), and other vehicles. Moreover, the information necessary for traveling of the host vehicle M during driving assistance may include a part or all of the information necessary for traveling of the host vehicle M during manual driving.

The second display 32E is installed, for example, near the center of the instrument panel IP. The second display 32E displays, for example, navigation results provided by a navigation device 50 as images. The second display 32E may also display television programs, play DVDs, or display content such as downloaded movies.

The vehicle sensor 40 includes a vehicle speed sensor configured to detect the speed of the host vehicle M, an acceleration sensor configured to detect acceleration, a yaw rate sensor configured to detect angular velocity around a vertical axis, a direction sensor configured to detect the direction of the host vehicle M, and the like.

For example, the navigation device 50 includes a global navigation satellite system (GNSS) receiver 51, a navigation HMI 52, and a route decider 53. The navigation device 50 stores first map information 54 in a storage device such as a hard disk drive (HDD) or a flash memory.

The GNSS receiver 51 identifies the position of the host vehicle M based on signals received from GNSS satellites. The position of the host vehicle M may be identified or supplemented by an inertial navigation system (INS) using an output of the vehicle sensor 40.

The navigation HMI 52 includes a display device, a speaker, a touch panel, keys, and the like. The navigation HMI 52 may partially or entirely share constituent elements with the HMI 30 described above. For example, the occupant may input a destination of the host vehicle M to the navigation HMI 52 instead of, or in addition to, inputting the destination of the host vehicle M to the HMI 30.

For example, the route decider 53 decides a route (hereinafter referred to as a route on a map) from the position of the host vehicle M identified by the GNSS receiver 51 (or any input position) to a destination input by the occupant using the HMI 30 or the navigation HMI 52 with reference to the first map information 54.

The first map information 54 is, for example, information in which a road shape is expressed by a link indicating a road and nodes connected by the link. The first map information 54 may include curvature of a road, point of interest (POI) information, and the like. The route on the map is output to the MPU 60.

The navigation device 50 may provide route guidance using the navigation HMI 52 based on a route on a map. The navigation device 50 may be implemented, for example, by a function of a terminal device such as a smartphone or a tablet owned by the occupant. The navigation device 50 may transmit the current position and the destination to a navigation server via the communication device 20, and may acquire a route equivalent to the route on the map from the navigation server.

For example, the MPU 60 includes a recommended lane decider 61 and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62.

For example, the recommended lane decider 61 decides in what lane numbered from the left the vehicle will travel. The recommended lane decider 61 decides the recommended lane so that the host vehicle M can travel along a reasonable route for traveling to a branching destination when there is a branch point on the route on the map.

The second map information 62 is map information with higher accuracy than the first map information 54. The second map information 62 includes, for example, information about lane centers or information about lane boundaries. Moreover, the second map information 62 may include road information, traffic regulation information, address information (addresses and postal codes), facility information, telephone number information, and the like. The second map information 62 may be updated as needed through communication between the communication device 20 and other devices.

The driving operation elements 80 include, for example, an accelerator pedal, a brake pedal, a shift lever, a steering wheel, a variant steering device, a joystick, and other operation elements. Sensors for detecting an operation amount or the presence or absence of an operation are attached to the driving operation elements 80, and detection results thereof are output to some or all of the autonomous driving control device 100, the travel driving force output device 200, the brake device 210, and the steering device 220.

For example, a sensor attached to the steering wheel (hereinafter referred to as a steering sensor) detects a weak electric current generated when the occupant touches the steering wheel (e.g., a change in capacitance). Moreover, the steering sensor may detect a steering torque generated about a rotation axis (shaft) of the steering wheel. If an electric current or a steering torque is detected, the steering sensor outputs a signal indicating the detection result to the autonomous driving control device 100.

When operated by an occupant, the turn signal lever 85 (also referred to as a stalk or a switch), causes turn signals (turn lamps or turn signals) attached to the front, rear, left, and right of the host vehicle M to be turned on. Moreover, the turn signal lever 85 is operated to issue an instruction to make a lane change of the host vehicle M, or to approve a lane change proposed by the autonomous driving control device 100. The instruction to make the lane change by operating the turn signal lever 85 is also referred to as a one-touch function. The turn signal lever 85 is an example of an “input interface.”

In addition, the instruction to make the lane change or the approval of the proposed lane change may be performed, in addition to or instead of operating the turn signal lever 85, by inputting a voice to a microphone included in the HMI 30, or by operating switches or buttons included in the HMI 30. In this case, the HMI 30 is another example of the “input interface.”

An in-vehicle camera 90 is a camera that captures images of the interior of the host vehicle M. The in-vehicle camera 90 is, for example, a digital camera using a solid-state imaging element such as a CCD or a CMOS. When the in-vehicle camera 90 captures images of the interior of the host vehicle M, image data is output to the autonomous driving control device 100.

The autonomous driving control device 100 includes, for example, a first controller 120, a second controller 160, a third controller 170, and a storage 190. Each of the first controller 120, the second controller 160, and the third controller 170 is implemented, for example, by a hardware processor such as a central processing unit (CPU) or a graphics processing unit (GPU) executing a program (software). Moreover, some or all of the above constituent elements may be implemented by hardware (including a circuit; circuitry) such as a large-scale integration (LSI) circuit, an application-specific integrated circuit (ASIC), a field-programmable gate array (FPGA), or a system on chip (SOC) or may be implemented by software and hardware in cooperation. The above-described program may be pre-stored in a storage device (a storage device including a non-transitory storage medium) such as an HDD or a flash memory of the autonomous driving control device 100 or may be stored in a removable storage medium such as a digital versatile disc (DVD) or a compact disc- read-only memory (CD-ROM), and installed in the HDD or the flash memory of the autonomous driving control device 100 when the storage medium (the non-transitory storage medium) is mounted on a drive device or the like.

The storage 190 may be implemented by the above-described various types of storage devices. The storage 190, for example, may be implemented by an HDD, a flash memory, an electrically erasable programmable read only memory (EEPROM), a ROM, a random-access memory (RAM), or the like. The storage 190, for example, stores a program (commands) and the like to be read and executed by a processor.

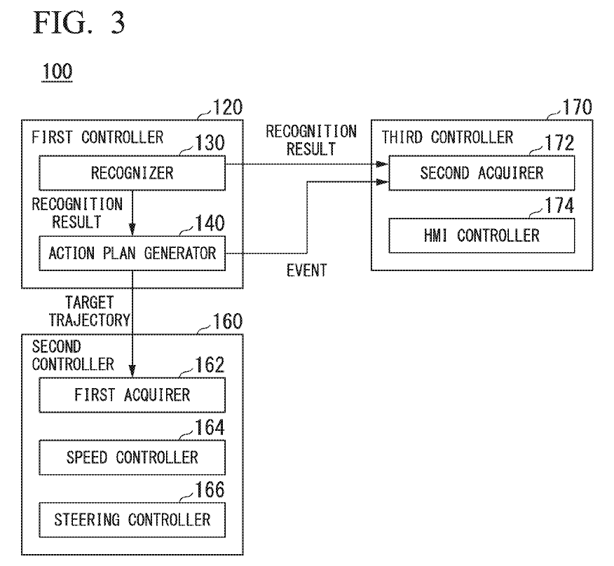

FIG. 3 is a diagram showing an example of a functional configuration of a first controller 120, a second controller 160, and a third controller 170 according to the first embodiment. The first controller 120 includes, for example, a recognizer 130 and an action plan generator 140.

The first controller 120 implements, for example, a function of artificial intelligence (AI) and a function of a predetermined model in parallel. For example, an “intersection recognition” function may be implemented by executing intersection recognition based on deep learning or the like and recognition based on previously given conditions (signals, road signs, or the like, with which pattern matching is possible) in parallel and performing comprehensive evaluation by assigning scores to both recognitions. Thereby, the reliability of autonomous driving is secured.

The recognizer 130 recognizes a surrounding situation or environment of the host vehicle M. For example, the recognizer 130 recognizes physical objects located around the host vehicle M based on information input from the camera 10, the radar device 12, and the LIDAR 14 via the physical object recognition device 16. The physical objects recognized by the recognizer 130 include, for example, bicycles, motorcycles, four-wheeled vehicles, pedestrians, road signs, road markings, lane lines, utility poles, guardrails, fallen objects, and the like. Moreover, the recognizer 130 recognizes states of the physical objects, such as positions, velocities, and accelerations. The position of the physical object, for example, is recognized as a position on relative coordinates (i.e., a position relative to the host vehicle M) with a representative point (the center of gravity, the center of a drive shaft, or the like) of the host vehicle M as the origin, and is used for control. The position of the physical object may be indicated by a representative point such as the center of gravity or a corner of the physical object or may be indicated by an area that has been represented. The “state” of the physical object may include, for example, the acceleration or jerk of the physical object, or the “action state” (e.g., whether or not another vehicle is changing lanes or is about to change lanes).

Moreover, the recognizer 130 recognizes, for example, a lane in which the host vehicle M is traveling (hereinafter referred to as the host lane) and other lanes adjacent to the host lane (hereinafter referred to as adjacent lanes). For example, the recognizer 130 recognizes the host lane, adjacent lanes, and the like by comparing a pattern of road markings (e.g., an arrangement of solid lines and broken lines) obtained from the second map information 62 with a pattern of road markings around the host vehicle M recognized from images captured by the camera 10.

Moreover, the recognizer 130 may recognize lanes such as the host lane and adjacent lanes by recognizing travel path boundaries (road boundaries) including road markings, road shoulders, curbstones, medians, guardrails, and the like as well as road markings. In this recognition, the position of the host vehicle M obtained from the navigation device 50 and processing results of the INS may be taken into account. Moreover, the recognizer 130 may recognize stop lines, obstacles, red traffic signals, toll gates, and other road events.

When recognizing the host lane, the recognizer 130 recognizes a relative position and posture of the host vehicle M with respect to the host lane. For example, the recognizer 130 may recognize a deviation of a reference point of the host vehicle M from the center of the lane and an angle formed between the travel direction of the host vehicle M and a line connected to the center of the lane as a relative position and orientation of the host vehicle M related to the host lane. Alternatively, the recognizer 130 may recognize the position of the reference point of the host vehicle M with respect to any side end of the host lane (the road marking or the road boundary) or the like as a position of the host vehicle M relative to the host lane.

When the host vehicle M is under autonomous driving on a route for which a recommended lane has been decided, the action plan generator 140 decides a traveling aspect of the autonomous driving. Hereinafter, information defining the traveling aspect of the autonomous driving will be described as an “event.”

The events include, for example, a constant-speed traveling event, a tracking traveling event, a lane change event, a branching event, a merging event, a takeover event, and the like. The constant-speed traveling event is a traveling aspect in which the host vehicle M travels in the same lane at a constant speed. The tracking traveling event is a traveling aspect in which the host vehicle M tracks another vehicle (hereinafter referred to as a preceding vehicle) that is located within a predetermined distance (e.g., within 100 m) in front of the host vehicle M in the host lane and is closest to the host vehicle M.

“Tracking” may be, for example, a traveling aspect in which an inter-vehicle distance (relative distance) between the host vehicle M and the preceding vehicle is maintained constant, or a traveling aspect in which, in addition to maintaining the inter-vehicle distance constant, the host vehicle M is caused to travel at the center of the host lane.

The lane change event is a traveling aspect in which the host vehicle M is caused to make the lane change from the host lane to an adjacent lane. The branching event is a traveling aspect in which the host vehicle M is caused to move to a lane toward a destination at a branch point of the road. The merging event is a traveling aspect in which the host vehicle M is caused to merge into a main lane at a merge point. The takeover event is a traveling aspect in which autonomous driving is terminated and driving is switched to manual driving.

Moreover, the events may include, for example, an overtaking event, an avoidance event, and the like. The overtaking event is a traveling aspect in which the host vehicle M is caused to temporarily make the lane change to an adjacent lane, overtake a preceding vehicle in the adjacent lane, and then make the lane change for returning to the original lane. The avoidance event is a traveling aspect in which the host vehicle M is caused to perform at least one of braking and steering to avoid an obstacle located in front of the host vehicle M.

Moreover, the action plan generator 140 may, for example, change an event already decided for a current segment to another event, or decide a new event for the current segment, in accordance with surrounding situations recognized by the recognizer 130 while the host vehicle M is traveling.

Moreover, the action plan generator 140 may decide an event in accordance with the occupant’s operation on the turn signal lever 85 (or a switch or button used in place thereof). For example, when the occupant operates the turn signal lever 85 to indicate a left turn, the action plan generator 140 decides a lane change event that causes the host vehicle M to make the lane change to the adjacent lane on the left side as viewed from the host vehicle M. Moreover, when the occupant operates the turn signal lever 85 to indicate a right turn, the action plan generator 140 decides a lane change event that causes the host vehicle M to make the lane change to the adjacent lane on the right side as viewed from the host vehicle M.

In principle, the action plan generator 140 generates a future target trajectory along which the host vehicle M is caused to automatically travel (without relying on a driver’s operation) in a traveling aspect defined by an event so that the host vehicle M travels in the recommended lane decided by the recommended lane decider 61 and further takes an action for a surrounding situation while traveling in the recommended lane. The target trajectory includes, for example, position elements for defining future positions of the host vehicle M and speed elements for defining future speeds and the like of the host vehicle M.

For example, the action plan generator 140 decides, as position elements of the target trajectory, a plurality of points (trajectory points) that the host vehicle M should sequentially reach. Each trajectory point is a point that the host vehicle M should reach at each predetermined travel distance (e.g., several meters [m]). The predetermined travel distance may be calculated, for example, based on a distance measured along the road when traveling along the route

Moreover, the action plan generator 140 decides, as the speed elements of the target trajectory, a target speed and a target acceleration at each predetermined sampling time (e.g., about 0.x [sec] where x is a decimal number). Moreover, each trajectory point may represent a position that the host vehicle M should reach at each sampling time. In this case, the target speed and the target acceleration are decided based on the sampling time and intervals between trajectory points. The action plan generator 140 outputs information indicating the generated target trajectory to the second controller 160.

The second controller 160 controls the travel driving force output device 200, the brake device 210, and the steering device 220 so that the host vehicle M passes through the target trajectory generated by the action plan generator 140 at scheduled times.

The second controller 160 includes, for example, a first acquirer 162, a speed controller 164, and a steering controller 166.

The first acquirer 162 acquires information about the target trajectory (trajectory points) from the action plan generator 140 and stores the information in a memory of the storage 190.

The speed controller 164 controls one or both of the travel driving force output device 200 and the brake device 210 based on speed elements (e.g., a target speed, target acceleration, or the like) included in the target trajectory stored in the memory.

The steering controller 166 controls the steering device 220 in accordance with position elements (e.g., curvature representing a degree of bending of the target trajectory) included in the target trajectory stored in the memory.

The processes of the speed controller 164 and the steering controller 166, for example, are implemented by a combination of feedforward control and feedback control. As an example, the steering controller 166 executes a combination of feedforward control according to the curvature of the road in front of the vehicle M and feedback control based on the deviation from the target trajectory.

The travel driving force output device 200 outputs a travel driving force (torque) for enabling the traveling of the host vehicle M to driving wheels. For example, the travel driving force output device 200 includes a combination of an internal combustion engine, an electric motor, a transmission, and the like, and a power electronic control unit (ECU) that controls the internal combustion engine, the electric motor, the transmission, and the like. The power ECU controls the above-described constituent elements in accordance with information input from the second controller 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated according to an operation on the brake pedal included in the driving operation elements 80 to the cylinder via a master cylinder as a backup. In addition, the brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes directions of steerable wheels by applying a force to a rack and pinion mechanism. The steering ECU drives the electric motor in accordance with the information input from the second controller 160 or the information input from the driving operation element 80 to change the directions of the steerable wheels.

The third controller 170 includes a second acquirer 172 and an HMI controller 174.

The second acquirer 172 acquires, for example, recognition results from the recognizer 130 and information about events decided by the action plan generator 140. The second acquirer 172 provides various types of information, which are acquired, to the HMI controller 174.

The HMI controller 174 controls the HMI 30 based on the various types of information acquired by the second acquirer 172. The HMI controller 174 is an example of an “output controller.”

For example, the HMI controller 174 outputs the above-described guidance information (information for guiding an occupant so that the host vehicle M moves outside the host lane) using the HMI 30. At this time, the HMI controller 174 differentiates an output position of the guidance information in accordance with a type of movement outside the host lane.

### Processing flow

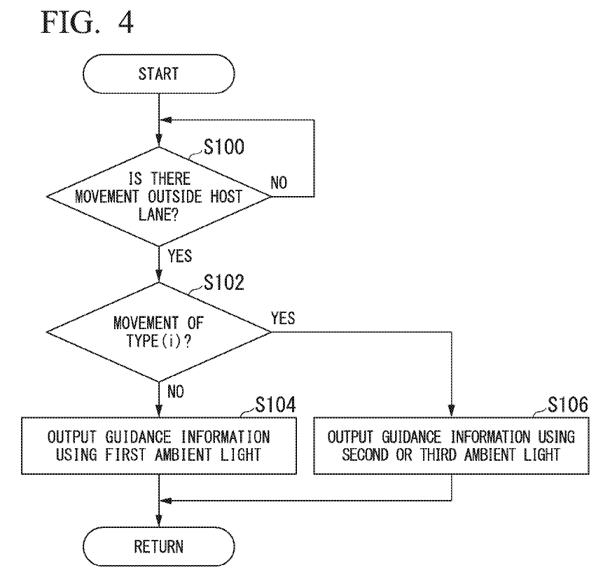

Hereinafter, a flow of a series of processing steps performed by the autonomous driving control device 100 according to the first embodiment will be described with reference to a flowchart. FIG. 4 is a flowchart showing an example of a flow of a series of processing steps performed by the autonomous driving control device 100 according to the first embodiment. The process of the present flowchart may be iteratively executed, for example, at a predetermined cycle.

First, the HMI controller 174 determines whether or not an event involving movement outside the host lane has been planned by the action plan generator 140 (step S100).

Events involving movement outside the host lane include, for example, a lane change event, an overtaking event, a branching event, and a merging event. That is, an event involving movement outside the host lane is an event that involves at least one of: (i) making the lane change from the host lane to an adjacent lane; (ii) moving to a branching road; (iii) moving from a merging road to a main road; and (iv) making a right turn or a left turn.

Subsequently, when an event involving movement outside the host lane has been planned, the HMI controller 174 determines whether or not the movement is of type (i) (step S102). That is, the HMI controller 174 determines whether or not the movement outside the host lane is a lane change from the host lane to an adjacent lane.

When the movement outside the host lane is not of type (i), i.e., when it is any one of the remaining types (ii) to (iv), the HMI controller 174 outputs the guidance information using the first ambient light 32A (step S104).

On the other hand, when the movement outside the host lane is of type (i), the HMI controller 174 outputs the guidance information using the second ambient light 32B or the third ambient light 32C (step S106). Thereby, the process of the present flowchart ends.

### Case of type (i)

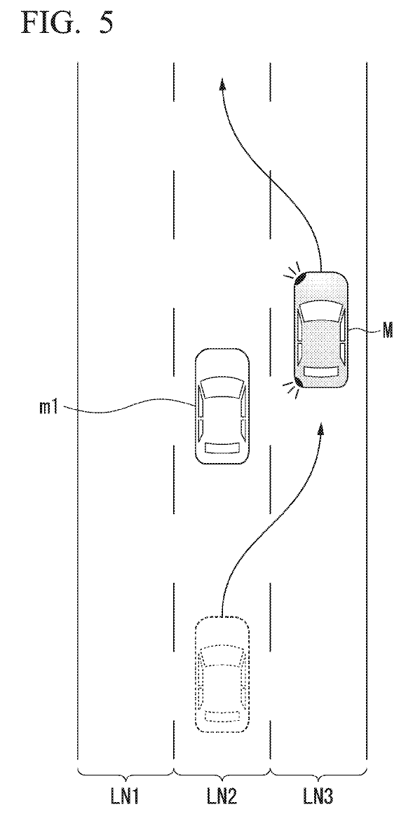

FIG. 5 is a diagram showing an example of a situation in which movement of type (i) is executed. In the example shown in FIG. 5, it is shown that, when the host vehicle M is traveling in a lane LN2, another vehicle m1 traveling at a lower speed than the host vehicle M is present. In this situation, an overtaking event is planned and the host vehicle M temporarily makes a lane change to an adjacent lane LN3 to overtake the other vehicle m1 and then returns to the original lane LN2. Such movement of the host vehicle M is classified as type (i). Therefore, the HMI controller 174 outputs the guidance information using the second ambient light 32B or the third ambient light 32C.

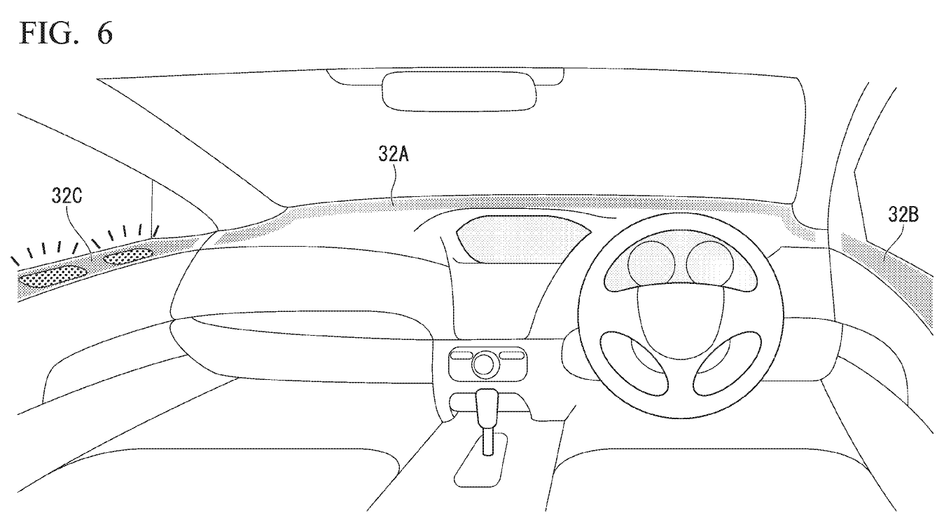

FIG. 6 is a diagram schematically showing a state in which the guidance information is output. For example, as in the example of FIG. 5, when a lane change to a lane LN2 located in the left direction with respect to a host lane LN3 is made, the HMI controller 174 outputs the guidance information using the third ambient light 32C, which is arranged on the left side as viewed by the occupant, between the second ambient light 32B and the third ambient light 32C.

For example, the HMI controller 174 turns on or blinks only the third ambient light 32C while turning off the first ambient light 32A and the second ambient light 32B. Thereby, it is possible to guide the occupant so that the host vehicle M moves in the left direction.

### Cases of types (ii) to (iv)

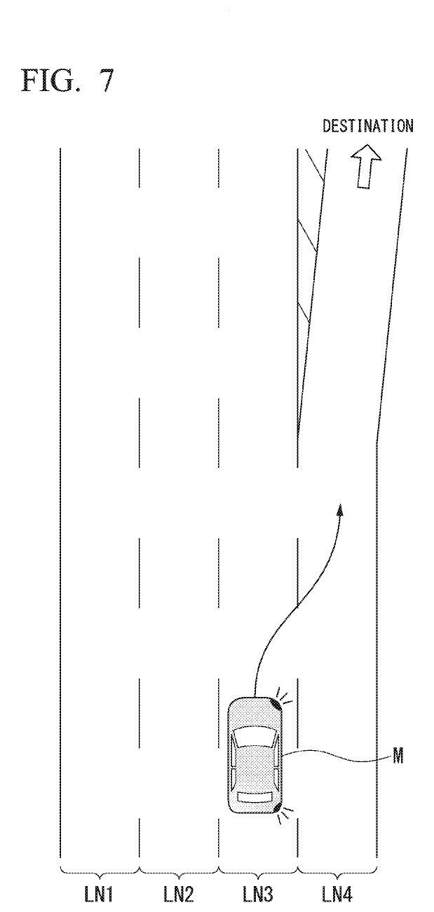

FIG. 7 is a diagram showing an example of a situation in which movement of any one of types (ii) to (iv) is executed. In the example shown in FIG. 7, it is shown that, when the host vehicle M is traveling in a lane LN3, a branching road LN4 on which a destination is located is approaching. In this situation, a branching event is planned, and the host vehicle M moves from the host lane LN3 to the branching lane LN4. This movement of the host vehicle M is classified as type (ii). Therefore, the HMI controller 174 outputs the guidance information using the first ambient light 32A.

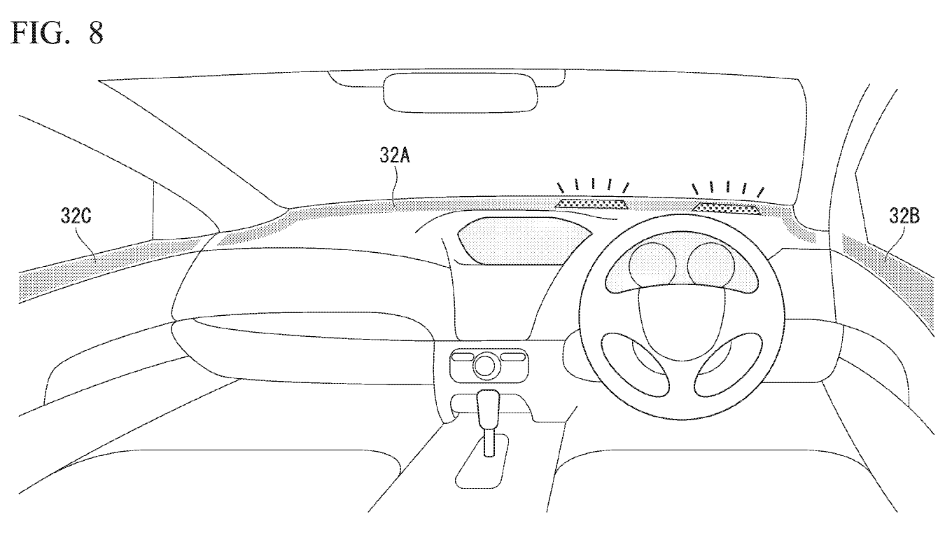

FIG. 8 is a diagram schematically showing a state in which the guidance information is output. For example, as in the example of FIG. 7, when the host vehicle M moves from a host lane LN3 to a branching lane LN4, the HMI controller 174 outputs the guidance information using a region around the driver’s seat of the first ambient light 32A, which is provided to surround the driver’s seat and the passenger seat.

For example, the HMI controller 174 turns on or blinks only the first ambient light 32A for a region around the driver’s seat while turning off the first ambient light 32A for a region around the passenger seat. Thereby, it is possible to guide the occupant so that the host vehicle M moves in the right direction.

According to the first embodiment described above, the autonomous driving control device 100 outputs guidance information, which is information for guiding the occupant so that the host vehicle M moves outside the host lane, using the HMI 30 (in particular, the first ambient light 32A, the second ambient light 32B, and the third ambient light 32C). Furthermore, the autonomous driving control device 100 differentiates the output position of the guidance information in accordance with the types (i) to (iv) of movement outside the host lane. Thereby, it is possible to reduce a sense of anxiety experienced by the occupant when the host vehicle M moves.

Furthermore, according to the first embodiment described above, the autonomous driving control device 100 uses different ambient lights to be turned on or blinked according to whether the movement outside the host lane is of type (i) or of types (ii) to (iv). Thereby, it is possible to notify the occupant whether the movement outside the host lane remains within the main road or involves moving outside the main road.

Furthermore, according to the first embodiment described above, because the first ambient light 32A is provided on the instrument panel IP and the second ambient light 32B and the third ambient light 32C are provided on the door trims, the occupant can recognize the type of movement outside the host lane through peripheral vision without directly gazing at it.

### Modification example of first embodiment

Hereinafter, a modification example of the first embodiment will be described. Although a case where the guidance information is output using the first ambient light 32A, the second ambient light 32B, and the third ambient light 32C has been described in the above-described first embodiment, the present invention is not limited thereto.

For example, the HMI controller 174 may output the guidance information using the speaker 34. Specifically, the HMI controller 174 may cause the speaker 34 to output a predetermined sound synchronized with a lighting or blinking rhythm of any one of the ambient lights.

Furthermore, the HMI controller 174 may output the guidance information using the first display 32D or the second display 32E.

### Second embodiment

Hereinafter, a second embodiment will be described. The second embodiment is different from the first embodiment described above in that an occupant decides whether to approve or reject movement of the host vehicle M in accordance with the guidance information. This difference will be mainly described below.

### Processing flow

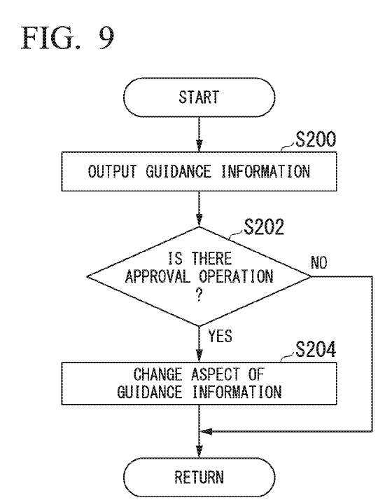

FIG. 9 is a flowchart showing an example of a flow of a series of processing steps performed by the autonomous driving control device 100 according to the second embodiment.

First, the HMI controller 174 outputs the guidance information using the HMI 30 as described above (step S200). This guidance information includes proposing any one of movements of types (i) to (iv) to the occupant.

Subsequently, the HMI controller 174 determines whether an approval operation has been performed by the occupant (step S202).

The approval operation is a process for operating the turn signal lever 85 to decide whether to approve or reject the proposed movement outside the host lane using the turn signal lever 85. Specifically, the approval operation is a process for operating the turn signal lever 85 to activate a turn signal in a direction identical to the direction of the proposed movement outside the host lane, among a plurality of turn signals provided on the left and right sides of the host vehicle M.

In addition, the approval of the proposal may be performed by inputting a voice to a microphone included in the HMI 30, or may be performed by operating a switch or button included in the HMI 30.

For example, as shown in FIG. 7, it is assumed that movement from the host lane LN3 to the branching lane LN4 is proposed. In this case, when the occupant pushes down the turn signal lever 85 to activate the turn signal on the right side of the host vehicle M, the HMI controller 174 determines that an operation for pushing down the turn signal lever 85 is an approval operation. On the other hand, when the occupant pushes up the turn signal lever 85 to activate the turn signal on the left side of the host vehicle M, the HMI controller 174 determines that an operation for pushing up the turn signal lever 85 is a rejection operation (cancel operation).

When the approval operation has been performed, the HMI controller 174 changes an output aspect of the guidance information (step S204).

For example, in response to the approval operation, the HMI controller 174 may change a lighting or blinking speed, or change a lighting or blinking pattern, when turning on or blinking any one of the first ambient light 32A, the second ambient light 32B, and the third ambient light 32C.

Furthermore, in accordance with the approval operation, the HMI controller 174 may cause the speaker 34 to output a chord sound obtained by adding a predetermined sound to an operation sound of the turn signal (so-called clickety-clack sound).

In this manner, by changing lighting or blinking aspects of various ambient lights or changing aspects of sounds output from the speaker 34 in accordance with the approval operation, it is possible to notify the occupant that the approval operation has been accepted by the autonomous driving control device 100.

According to the second embodiment described above, when an approval operation is input to the turn signal lever 85 or the HMI 30, the autonomous driving control device 100 differentiates the output aspect of the guidance information. As a result, it is possible to notify the occupant that the approval operation has been accepted by the autonomous driving control device 100, and it is possible to further reduce a sense of anxiety experienced by the occupant when the host vehicle M moves.

Although modes for carrying out the present invention have been described using embodiments, the present invention is not limited to the embodiments and various modifications and substitutions can also be made without departing from the scope and spirit of the present invention.

What is claimed is:

1. An information output device comprising:
an output interface provided in a cabin of a vehicle; and
an output controller configured to use the output interface to output guidance information that is information for guiding an occupant so that a vehicle moves outside a host lane that is a lane in which the vehicle is traveling among one or more lanes formed on a road where the vehicle is located,
wherein the output controller differentiates an output position of the guidance information in accordance with a type of movement.

2. The information output device according to claim 1,
wherein the output interface includes a first optical notifier and a second optical notifier installed at a position different from that of the first optical notifier, and
wherein the output controller
outputs the guidance information using the first optical notifier when the movement is a lane change to an adjacent lane that is adjacent to the host lane; and
outputs the guidance information using the second optical notifier when the movement is movement from the road to a branching road, when the movement is movement from a merging road that connects the road and another road to the other road, when the movement is a right turn, or when the movement is a left turn,

3. The information output device according to claim 1, wherein the guidance information includes a proposal of the movement for the occupant.

4. The information output device according to claim 3, further comprising an input interface operated by the occupant,
wherein, when an approval operation, which is an operation by the occupant for approving the proposal, is input to the input interface, the output controller differentiates an aspect of the guidance information to be output using the output interface.

5. The information output device according to claim 4,
wherein the input interface includes a turn signal lever, and
wherein the approval operation is an operation in which the turn signal lever is operated to actuate, among a plurality of turn signals provided on left and right sides of the vehicle, a turn signal in a direction identical to a direction of the movement proposed for the occupant.

6. The information output device according to claim 4,
wherein the output interface includes a speaker, and
wherein the output controller:
causes the guidance information to be output as a sound from the speaker; and
differentiates an aspect of the sound output from the speaker when the approval operation is input to the input interface.

7. The information output device according to claim 2,
wherein the first optical notifier is provided on an inner side of a door of the vehicle, and
wherein the second optical notifier is provided on an instrument panel of the vehicle.

8. An information output method using a computer mounted on a vehicle where an output interface is provided in a cabin, the information output method comprising:
using the output interface to output guidance information that is information for guiding an occupant so that a vehicle moves outside a host lane that is a lane in which the vehicle is traveling among one or more lanes formed on a road where the vehicle is located; and
differentiating an output position of the guidance information in accordance with a type of movement.

9. A non-transitory storage medium storing a program for causing a computer, which is mounted on a vehicle where an output interface is provided in a cabin, to:
use the output interface to output guidance information that is information for guiding an occupant so that a vehicle moves outside a host lane that is a lane in which the vehicle is traveling among one or more lanes formed on a road where the vehicle is located; and
differentiate an output position of the guidance information in accordance with a type of movement.
